(19) United States
(12) Patent Application Publication
(10) Pub. No.: US 2013/0346420 A1
(43) Pub. Date: Dec. 26, 2013

(54) Method And System For Identifying Aberrant Wireless Behavior

(71) Applicants: Scot Douglas Gordon, Redmond, WA (US); Dmitry Kaplan, Bellevue, WA (US); Raul Vera, Aliso Viejo, CA (US)

(72) Inventors: Scot Douglas Gordon, Redmond, WA (US); Dmitry Kaplan, Bellevue, WA (US); Raul Vera, Aliso Viejo, CA (US)

(73) Assignee: POLARIS WIRELESS, INC., Mountain View, CA (US)

(21) Appl. No.: 13/531,028

(22) Filed: Jun. 22, 2012

(51) Int. Cl. G06F 17/30

(52) U.S. Cl. 707/748; 707/E17.033

(57) ABSTRACT

A behavior analysis system analyzes large volumes of records that report on telecommunications events associated with wireless terminals. The behavior analysis system filters the large volume of available records based on investigation-specific rules, resulting in a set of candidate wireless terminals. The illustrative embodiment determines a pattern of behavior for each candidate. Each candidate is measured for how precisely it satisfies the investigation-specific rules. Each candidate is further analyzed for aberrations, if any, relative to the established pattern of behavior. An aberration tends to prove or disprove whether a candidate is more likely to be a true suspect in the given investigation. The illustrative embodiment ranks the set of candidates based on (i) a measure of how precisely each candidate wireless terminal satisfies the investigation-specific rule(s), and (ii) a measure of the aberration in behavior of each candidate wireless terminal relative to the respective pattern of behavior thereof.

### FIELD OF THE INVENTION

The present invention relates to wireless networks in general, and, more particularly, to analyzing wireless behavior.

### BACKGROUND OF THE INVENTION

When investigating a crime, a terrorist attack, a missing persons case, a threat, and like situations, the cost of a false positive is high. A falsely identified suspect can be irreparably harmed by a false positive. Conversely, the true suspect or perpetrator remains at large, and victims remain at risk.

FIG. 1 depicts a diagram of the salient components of wireless telecommunications network 100 in accordance with the prior art. Wireless telecommunications network 100 comprises: wireless terminal 101, cellular base stations 102-1, 102-2, and 102-3, Wi-Fi base stations 103-1 and 103-2, wireless switching center 111, and location system 112. Wireless telecommunications network 100 provides wireless telecommunications service to all wireless terminals within its coverage area, in well-known fashion.

Data that is generated by wireless network 100 can provide clues to the investigator. For example, a known suspect's calling records can be obtained to determine what telephone and/or data communications that suspect has engaged in. Network-supplied calling records are well known in the art, and typically comprise one or more of:
an International Mobile Subscriber Identity (“IMSI”) number that is assigned to the wireless terminal of the subscriber,
the telephone number assigned to the subscriber's account,
the origination time of the call,
the ending time of the call,
the origination time of a text (e.g., SMS) message,
the receiving time of a text (e.g., SMS) message, and
location information relative to the respective times, e.g., cell ID.

These records are often referred to as “call-detail records” or “CDRs.” CDRs are very useful in investigating a known suspect. However, for certain kinds of investigations, the suspects are not readily known and an investigator might face enormously large pools of possible suspects to identify and track down. For example, investigating the call-detail records of every subscriber in a city following a kidnapping is impractical and dangerous, as time is of the essence in finding the victim. And, as noted above, the cost of a false positive in the investigation can be prohibitive.

Therefore, an approach that reduces the risk of false positives would be useful and desirable.

### SUMMARY OF THE INVENTION

The present inventors recognized how to use data obtained from a wireless network without the costs and disadvantages in the prior art. The inventors recognized that investigators who face long lists of candidate suspects would greatly benefit from a system that can accurately rank candidates to identify those who are more likely the true suspect.

In the kidnapping example above, an investigator would like to identify the likely suspects from among all wireless subscribers in a city. In the case of a bomb blast, for example, an investigator would like to identify the likely suspects from among the many subscribers who were using wireless terminals at or near the site and time of the bomb blast. Candidate suspects could be found by searching through calling records and other data obtained from a wireless network, for example by constructing queries with geographic and temporal constraints. However, such an exercise could lead to an impractically large list of candidate suspects. Instead, by ranking the candidates according to relevant criteria, the investigator could more quickly and accurately identify the likely suspects. Accordingly, the illustrative system and accompanying methods according to the present invention provide:
another dimension to sorting and ranking persons of interest, and
indicators of changed wireless behavior, and
distinctions as between different wireless users according to behaviors.

Notably, the term “behavior” is contrasted herein to the term “usage,” which indicates how a wireless terminal is used, e.g., what numbers it dials, what calls it receives, activations, deactivations, features used, etc. In contrast, “behavior” comprises more than usage, including location of the wireless terminal and thus movement, which correlate more closely with the behavior of the terminal's user beyond the mere operation of the terminal. Consequently, the sorting and ranking according to the illustrative embodiment is largely based on location data that has been gleaned about the wireless terminals.

Wireless networks typically generate a variety of records for every subscriber in the network. Even for subscribers with unlimited calling plans, the wireless network typically generates a call-detail record for every call and text message involving the subscriber. Data sessions also generate records. In general, a telecommunications event can relate to voice, text, data, or other activity at the wireless terminal, such as a powering on or off of the wireless terminal. A telecommunications-event record is generated, comprising location information for the wireless terminal at the time of the telecommunications event. Probes that monitor certain network interfaces also can be used to glean information in the network needed to generate telecommunications-event records. The detail, resolution, and precision of the location information in a telecommunications-event record varies by network. The granularity of the telecommunications events that are recorded also varies.

The present inventors devised systems and methods that exploit the totality of available telecommunications-event records and other data obtained from one or more wireless networks to enable investigators to establish geographic, temporal, and behavioral criteria that, when collectively applied to a large number of wireless terminals will produce a ranked ordering of candidates that is more manageable and represents a more likely list of suspects. Data from WiFi or VoIP networks can be similarly exploited.

It should be noted that call detail records are used in commercial applications to target mobile users for marketing and advertising messages. In such applications, the cost of a false positive can be considered negligible. For example, pushing a coupon to someone who is not the right target is relatively harmless to the individual, even if a dollar cost is associated with it. Likewise, displaying an advertisement or a weather warning to a mobile user passing through a targeted area—even when the user is poorly chosen—has a negligible cost to everyone involved. In contrast, as noted earlier, the risk of harm to a falsely identified suspect can be very high, especially when coupled with the societal risk that the true suspect is still at large. This is why law enforcement applications require a different approach in using and analyzing telecommunications-event records (and other data) than what is typical in the commercial sector.

The illustrative embodiment is a “behavior analysis system” that enables investigators to establish investigation-specific criteria to analyze large volumes of records that report on telecommunications events associated with wireless terminals in one or more wireless networks. In regard to a given investigation, an investigator can define rules that are relevant to the circumstances of the investigation. The rules comprise geographic, temporal, telephony, and data constraints, and combinations thereof. The behavior analysis system filters the large volume of available records. The result is a smaller set of candidate wireless terminals that correspond to the filtered records that satisfy the investigation-specific rule(s), but it should be noted that in alternative embodiments the set of candidates includes all wireless terminals that have a telecommunications-event record.

Further, the illustrative embodiment analyzes the set of candidates to determine a pattern of behavior for each candidate. A pattern of behavior covers an extended period of time, such as three months or a year preceding the timeframe of the investigation. Additionally, each candidate is analyzed to measure how precisely it satisfies the investigation-specific rule(s). Each candidate is further analyzed for aberrations in behavior, if any, in connection with the parameters of the investigation-specific rule(s) relative to the established pattern of behavior. An aberration as defined and used herein tends to prove or disprove whether a candidate is more likely to be a true suspect in the investigation. Accordingly, an aberration is probative of whether the aberrant behavior indicates a likely true suspect.

The illustrative embodiment ranks the set of candidates based on:
(i) a measure of how precisely each candidate wireless terminal satisfies the investigation-specific rule(s), and
(ii) a measure of the aberration in behavior of each candidate wireless terminal relative to the respective pattern of behavior thereof.

The resulting ranking, comprising the ranked set of the candidates is then transmitted by the illustrative embodiment to a display, to another system, or to a data store, or any combination thereof. The ranking provides the investigator with an opportunity to identify those who are the more likely true suspects. The ranking thus provides an important new dimension in the investigator's analysis and focuses specifically on behavior-related criteria that could be relevant to the investigation. The focus is meant to reduce the rate of false positives in the investigation and to raise the accuracy and speed of the investigation. The present inventors have empirically demonstrated improved results according to the principles of the illustrative embodiment. Notably, the location data, and impliedly, the inferred movement of the wireless terminals being analyzed, provide an important added dimension to the ranking according to the illustrative embodiment.

A simple example will illustrate some of the salient principles. When two disparate geographic areas are under surveillance, e.g., area A and area B, anyone who visited area A and/or area B is a candidate for further investigation (the reasons why are outside the scope of the example). According to the illustrative embodiment, a wireless terminal who visited both area A and area B would be ranked higher than those who only visited either A or B but not both. This illustrates both (i) the filtering aspect of the illustrative embodiment, which filters out wireless terminals in neither area A nor area B, and (ii) the behavioral-ranking aspect. In this simple example, the ranking is based on a measure of how precisely each candidate wireless terminal satisfies the investigation-specific rules. Accordingly, an illustrative measure of how precisely a wireless terminal satisfies the rules is the visiting of both sites. According to this measure, the A-and-B visitors are ranked higher than the A-or-B visitors, but the A-or-B visitors remain in the set of candidates. Although this example is very simple, the point is that rules of behavior that are relevant to the investigator can be defined and applied to an indefinitely large number of records to rank what could otherwise be an unmanageable number of candidates.

This simple example can be extended by further ranking the candidates based on behavior that is an aberration from the pattern of behavior. In this example, a visit to site A during the timeframe of the bomb blast would be considered an aberration if site A had not been visited before according to the established pattern of behavior. Likewise, a large number of wireless calls during the day of the bomb blast are an aberration relative to a pattern of behavior of only a handful of daily calls. Thus, according to the illustrative embodiment, those candidates who visited A-and-B and made a large number of calls on the day of the bomb blast would be ranked higher than candidates who visited A-or-B and exhibited no aberration in the number of calls. These illustrative behavioral traits indicate a higher likelihood, relative to others in the set of candidates, that the respective wireless terminal was used by a true suspect.

A method according to the illustrative embodiment is associated with a wireless network, the method comprising:
receiving, by a data-processing system, a plurality of records that report on telecommunications events associated with wireless terminals in the wireless network;
filtering the plurality of records, based on a rule, thereby resulting in a corresponding set of candidate wireless terminals, wherein the filtering is performed by the data-processing system;
for each candidate in the set, generating, by the data-processing system, a pattern of behavior that is based on records that are associated with the candidate over a period of time;
ranking, by the data-processing system, the set of candidates relative to each other based on:
(a) a measure of aberration in behavior of each candidate wireless terminal relative to the respective pattern of behavior thereof; and
transmitting, by the data-processing system, the ranked set of candidate wireless terminals.

### BRIEF DESCRIPTION OF THE DRAWINGS

FIG. 1 depicts a diagram of the salient components of wireless telecommunications network 100 in accordance with the prior art.

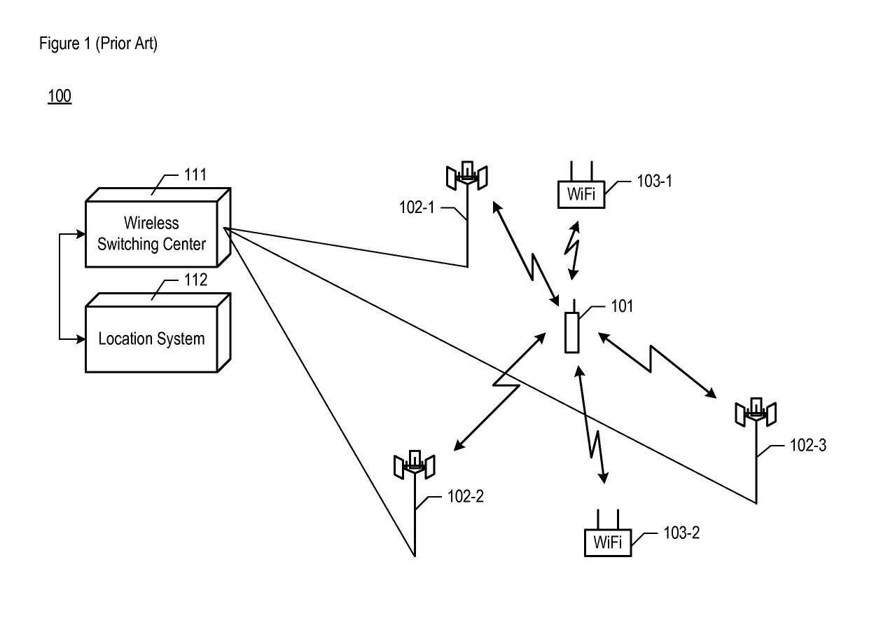

FIG. 2 depicts a diagram of the salient components of wireless telecommunications network 200 in accordance with the illustrative embodiment of the present invention.

FIG. 3 depicts a block diagram of the salient components of behavior analysis system 213 in accordance with the illustrative embodiment.

FIG. 4 depicts a flowchart of the salient operations of method 400 performed in accordance with the illustrative embodiment of the present invention.

FIG. 5 depicts a flowchart of the salient sub-operations of operation 401 performed in accordance with the illustrative embodiment.

FIG. 6 depicts a flowchart of the salient sub-operations of operation 405 performed in accordance with the illustrative embodiment.

FIG. 7 depicts a flowchart of the salient sub-operations of operation 409 performed in accordance with the illustrative embodiment.

### DETAILED DESCRIPTION

For the purposes of this specification, the following terms and their inflected forms are defined as follows:
The term “location” is defined as any one of a zero-dimensional point, a one-dimensional line, a two-dimensional area, or a three-dimensional volume. Thus, a location can be described, for example, by a street address or geographic coordinates or by a perimeter or by a cell ID or an enhanced cell ID.
The term “geofence” is defined as a virtual perimeter surrounding a geographic area, wherein the geographic area may remain static or change over time, such as by expanding, shrinking, “moving,” or any combination thereof. Therefore, a location can be a geofence, but is not so limited.
The term “record” is defined as any one of a call-detail record (“CDR”), a calling record, a data-session activity record, and any other record generated as a result of a telecommunications event that is experienced by the reported-on wireless terminal, or any combination thereof. The term “record” is used synonymously herein with “telecommunications-event record.” A telecommunications-event record reports on telecommunications event(s) that are associated with a wireless terminal, whether they are reported by the wireless terminal itself or by another element of the wireless network, e.g., a base station controller. The telecommunications-event record comprises location information about the location of the wireless terminal when it experienced the reported-on telecommunications event.
The term “wireless terminal” is defined as an apparatus that:
   (i) receives signals from another apparatus without a wire, or
   (ii) transmits signals to another apparatus without a wire, or
   (iii) both (i) and (ii).
This term is used synonymously herein with the following terms: wireless telecommunications terminal, user equipment, mobile terminal, and mobile unit.

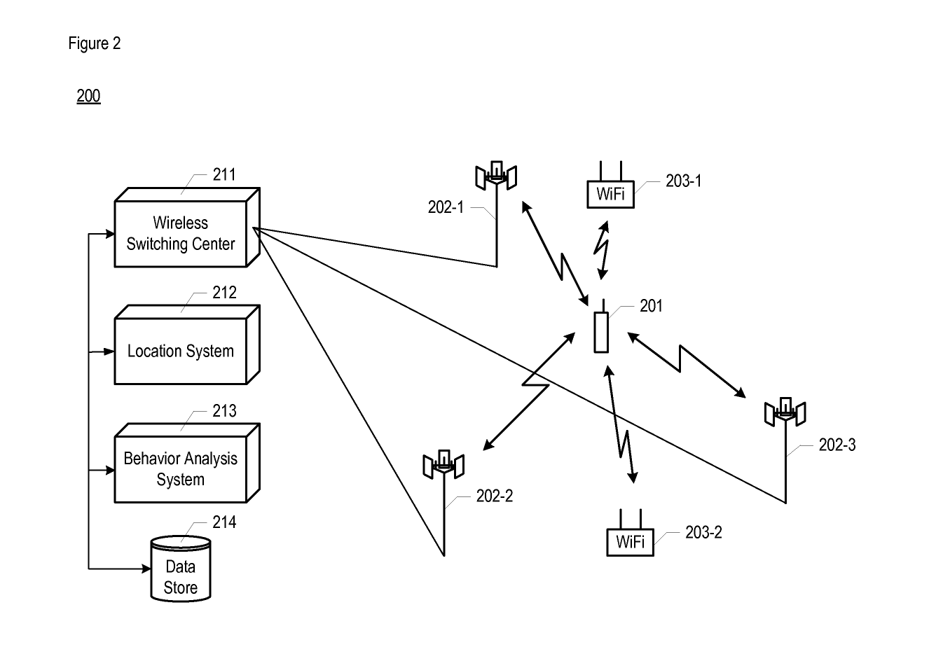

FIG. 2 depicts a diagram of the salient components of wireless telecommunications network 200 in accordance with the illustrative embodiment of the present invention. Wireless network 200 comprises wireless terminal 201, cellular base stations 202-1, 202-2, and 202-3, Wi-Fi base stations 203-1 and 203-2, wireless switching center 211, location system 212, behavior analysis system 213, and data store 214, which are interrelated as shown. Wireless network 200 provides wireless telecommunications service to all wireless terminals within its coverage area in well-known fashion; in addition, behavior analysis system 213 performs and coordinates the operations as described in more detail below.

In accordance with the illustrative embodiment, wireless telecommunications service is provided to wireless terminal 201 in accordance with the air-interface standard of the 3rd Generation Partnership Project (“3GPP”). Examples of 3GPP air-interface standards include GSM, UMTS, and LTE. After reading this disclosure, however, it will be clear to those skilled in the art how to make and use alternative embodiments of the present invention that operate in accordance with one or more other air-interface standards (e.g., CDMA-2000, IS-136 TDMA, IS-95 CDMA, 3G Wideband CDMA, IEEE 802.11 Wi-Fi, 802.16 WiMax, Bluetooth, etc.) in one or more frequency bands.

Wireless terminal 201 comprises the hardware and software necessary to be 3GPP-compliant and to perform the processes described below and in the accompanying figures. Wireless terminal 201 is mobile. For example and without limitation, wireless terminal 201 is capable of:
measuring one or more traits of each of one of more electromagnetic signals (received from cellular base stations 202-1, 202-2, and 202-3 and Wi-Fi base stations 203-1 and 203-2) and of reporting the measurements to location engine 214, and
transmitting one or more signals to cellular base stations 202-1, 202-2, and 202-3 and Wi-Fi base stations 203-1 and 203-2, including reports of telecommunications events experienced by wireless terminal 201, and
receiving service from one or more of cellular base stations 202-1, 202-2, and 202-3 and Wi-Fi base stations 203-1 and 203-2.

Accordingly, examples of telecommunications events that are experienced and reported by wireless terminal 201 include without limitation:
a. an origination of a voice call by the wireless terminal,
b. a receiving of a voice call by the wireless terminal,
c. an establishment of a voice call between the wireless terminal in the wireless network and another telecommunications terminal, whether in the network or elsewhere, i.e., establishing a call connection,
d. an origination of a Short Message Service (“SMS”) message by the wireless terminal,
e. a receiving of an SMS message by the wireless terminal,
f. an origination of a text message by the wireless terminal,
g. a receiving of a text message by the wireless terminal,
h. a location update request that is transmitted by the wireless terminal to an element of the network infrastructure, wherein the location update request is caused by at least one of the following occurrences:
   i. powering on the wireless terminal,
   ii. detecting by the wireless terminal that it is in a new location area, and
   iii. originating a data session by the wireless terminal,
   iv. a handover of the wireless terminal from one serving cell to another cell,
   v. an International Mobile Subscriber Identity (“IMSI”) detach message that is transmitted by the wireless telecommunications terminal,
   vi. a powering off by the wireless telecommunications terminal,
   vii. an International Mobile Subscriber Identity (“IMSI”) attach message that is transmitted by the wireless telecommunications terminal when it powers on, and
   viii. a powering on by the wireless telecommunications terminal,
i. an origination by the wireless telecommunications terminal of an Unstructured Supplementary Service Data (“USSD”) session,
j. an origination of a data session by the wireless telecommunications terminal,
k. an ending of a data session by the wireless telecommunications terminal,
l. an activation, for the wireless telecommunications terminal, of a packet data protocol (“PDP”) context by a GPRS Support Node in the wireless network,
m. a deactivation, for the wireless telecommunications terminal, of a packet data protocol (“PDP”) context by a GPRS Support Node in the wireless network,
n. the wireless telecommunications terminal attaching to a packet radio data network in the wireless network, and
o. the wireless telecommunications terminal detaching from the packet radio data network in the wireless network.
   Telecommunications-event records are generated (as described below) that report on the above-listed telecommunications events. It will be clear to those having ordinary skill in the art how to recognize and implement the corresponding terms, if any, for non-3GPP types of wireless networks.

Wireless terminal 201 is illustratively a smartphone with both voice and data service provided and supported by wireless network 200. It will be clear to those having ordinary skill in the art, after reading the present disclosure, how to make and use wireless network 200 with wireless terminal 201 that is a cell phone, a data tablet, or a combination thereof. Although wireless network 200 comprises only one wireless terminal, it will be clear to those skilled in the art, after reading this disclosure, how to make and use alternative embodiments of the present invention that comprise any number of wireless terminals.

Cellular base stations 202-1, 202-2, and 202-3 communicate with wireless switching center 211 and with wireless terminal 201 via radio frequencies (“RF”) in well-known fashion. As is well known to those skilled in the art, base stations are also commonly referred to by a variety of alternative names such as access points, nodes, network interfaces, etc. Although the illustrative embodiment comprises three base stations, it will be clear to those skilled in the art, after reading this disclosure, how to make and use alternative embodiments of the present invention that comprise any number of base stations.

Cellular base stations 202-1, 202-2, and 202-3 comprise the hardware and software necessary to be 3GPP-compliant and to perform the processes described below and in the accompanying figures. For example and without limitation, cellular base stations 202-1, 202-2, and 202-3 are capable of, without limitation:
measuring one or more traits of each of one of more electromagnetic signals (transmitted by wireless terminal 201), and reporting the measurements to location system 212,
detecting one or more of the telecommunications events occurring at wireless terminal 201, and
transmitting one or more signals, and reporting the transmission parameters of those signals, and reporting telecommunications events to location system 212.

Wi-Fi base stations 203-1 and 203-2 communicate with wireless terminal 201 via radio frequencies (“RF”) in well-known fashion. Wi-Fi base stations 203-1 and 203-2 have a shorter range than cellular base stations 202-1, 202-2, and 202-3, but sometimes have a higher bandwidth. Wi-Fi base stations 203-1 and 203-2 are capable of, without limitation:
measuring one or more traits of each of one of more electromagnetic signals (transmitted by wireless terminal 201), and reporting the measurements to location system 212, and
detecting one or more of the telecommunications events occurring at wireless terminal 201, and
transmitting one or more signals, and reporting the transmission parameters of those signals, and reporting telecommunications events to location system 212.

It will be clear to those having ordinary skill in the art how to make and use alternative embodiments comprising base stations (cellular, WiFi, etc.) and/or access points that are not capable of reporting transmission parameters and/or measurements to a location system; in such configurations, it will be clear to those having ordinary skill in the art how to use probes to monitor the respective interface between the base station and/or access point and other network entities to gather measurement and event information from/about the wireless terminals and transmit the gathered information to the location system such as illustrative location system 212.

Wireless switching center 211 comprises a switch that orchestrates the provisioning of telecommunications service to wireless terminal 201 and the flow of information to and from location system 212, and behavior analysis system 213, and data store 214, as described below and in the accompanying figures. Wireless switching center 211 collects data from throughout wireless network 200, and generates telecommunications-event records according to the telecommunications events that are listed above, without limitation. Illustratively, wireless switching center 211 collects location data from location system 212, from the base stations, and from wireless terminal 201. Each telecommunications-event record associates the reported-on telecommunications event with a location datum. The location datum indicates a location at which the reported-on telecommunications event is estimated to have occurred. As previously noted, the resolution of the estimated location varies. Wireless switching center 211 transmits the telecommunications-event records to behavior analysis system 213 and to data store 214.

As is well known to those skilled in the art, wireless switching centers are also commonly referred to by other names such as mobile switching centers, mobile telephone switching offices, routers, packet data service nodes, GPRS support nodes, etc.

Although the illustrative embodiment comprises one wireless switching center, it will be clear to those skilled in the art, after reading this disclosure, how to make and use alternative embodiments of the present invention that comprise any number of wireless switching centers. In accordance with the illustrative embodiment, all of the base stations servicing wireless terminal 201 are associated with wireless switching center 211. It will be clear to those skilled in the art, after reading this disclosure, how to make and use alternative embodiments of the present invention in which any number of base stations are associated with any number of wireless switching centers. It will be further clear to those having ordinary skill in the art, after reading this disclosure, how to make alternative embodiments wherein wireless switching center 211 is not the entity that generates the telecommunications-event records, and instead location system 212 generates these records based on data gathered from probes; or a combination of center 211-generated and system 212-generated records.

Location system 212 comprises hardware and software that estimates one or more locations for wireless terminal 201. According to the illustrative embodiment, location system 212 is the OmniLocate wireless location platform product from Polaris Wireless, Inc. OmniLocate estimates a location that is associated with telecommunications events, including events other than call origination and termination—events such as location area updates for wireless terminals. Examples of telecommunications events that elicit a location estimate are given above in reference to wireless terminal 201. Thus, the OmniLocate platform enables wireless switching center 211 to generate and provide more granular telecommunications-event records than standard call-detail records, by transmitting more detailed (or precise) location information that is associated with more types of telecommunications events, e.g., a 10-meter by 10-meter area that is more precise than a cell ID. It will be clear to those having ordinary skill in the art, after reading the present disclosure, how to make and use alternative embodiments of the present invention that operate with location systems 212 other than Polaris Wireless' OmniLocate product. It will be clear to those having ordinary skill in the art, after reading the present disclosure, how to make and use alternative embodiments that use only prior-art call-detail records.

Behavior analysis system 213 is a data-processing system that is responsible for performing the wireless terminal behavior analysis according to the illustrative embodiment of the present invention. Behavior analysis system 213, which is an element of wireless network 200, executes and coordinates the operations described herein in reference to method 400. It will be clear to those having ordinary skill in the art, after reading the present disclosure, how to make and use alternative embodiments wherein behavior analysis system 213 communicates with wireless network 200, but is not an element thereof.

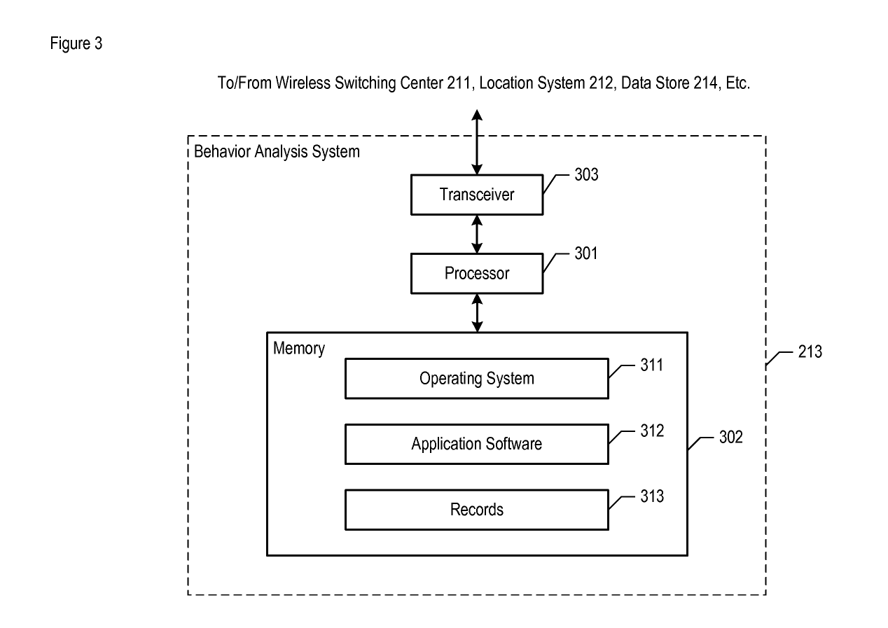

FIG. 3 depicts a block diagram of the salient components of the data-processing hardware platform for behavior analysis system 213 in accordance with the illustrative embodiment. Illustrative embodiment 213 is a data-processing system that comprises: processor 301, memory 302, and transceiver 303.

Processor 301 is a processing device such as a microprocessor that, in conjunction with the other components of illustrative embodiment 213, executes the software and processes the data according to the operations described herein. Processor 301 is well known in the art.

Memory 302 is a non-transitory and non-volatile memory that stores operating system 311, application software 312, and records 313. Memory 302 is well known in the art.

Transceiver 303 is a component that enables illustrative embodiment 213 to communicate electronically with other components internal and external to wireless network 200. For example, transceiver 303 enables communication pathways to/from wireless switching center 211, location system 212, data store 214, etc. Transceiver 303 is well known in the art.

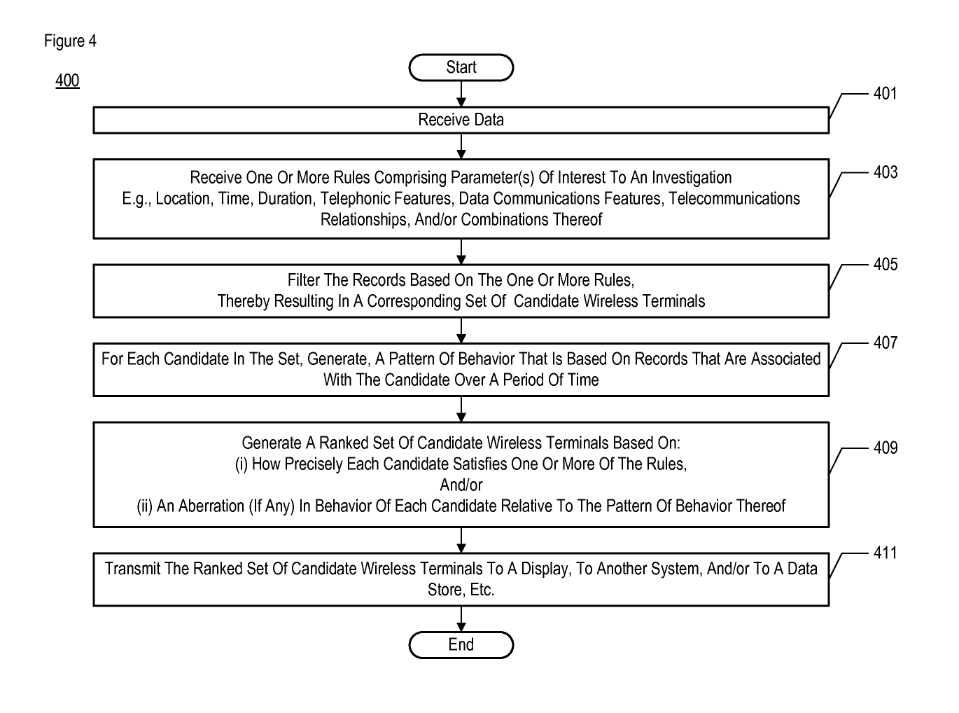

The specialized application software that is executed on the hardware platform by illustrative embodiment 213 enables the system to perform the operations in method 400, which is depicted in FIG. 4. It will be clear to those skilled in the art, after reading the present disclosure, that in alternative embodiments the data-processing hardware platform of behavior analysis system 213 can be embodied as a multi-processor platform, as a server, as a sub-component of a larger computing platform, or in some other computing environment—all within the scope of the present invention. It will be clear to those skilled in the art, after reading the present disclosure, how to make and use the data-processing hardware platform for behavior analysis system 213.

FIG. 4 depicts a flowchart of the salient operations of method 400 in accordance with the illustrative embodiment of the present invention. Behavior analysis system 213 executes and coordinates the operations of method 400 in accordance with the illustrative embodiment.

At operation 401, behavior analysis system 213 receives a plurality of data from one or more elements of one or more wireless networks. Illustratively, behavior analysis system 213 receives data from wireless switching center 211 and from data store 214, as is described in further detail in the next figure.

At operation 403, behavior analysis system 213 receives one or more rules comprising one or more parameters that are of interest to an investigation. Examples of parameters for an investigation-specific rule include without limitation: a location, a time, a duration, a telephonic feature, a data communications feature, or any combination thereof. Examples of a location include without limitation a perimeter, a high rise building having a given address, etc. Examples of a time include without limitation a time of day, a day of week, a day of year, a holiday, a date, a period of time, e.g., Tuesday from 10:00 to noon, etc. Examples of a duration include without limitation an interval from a first time of day to a second time of day, a number of days, etc. Examples of a telephonic feature include without limitation a multi-party call, an international call, a call transfer, a called telephone number, a calling telephone number, a text message origination number, a text message destination, an activation for a wireless terminal, a deactivation for a wireless terminal, etc. Examples of a data communications feature include without limitation an IP address, a data session parameter, a distribution list, etc. Other examples of relevant parameters include one or more of, without limitation:
the kinds of destinations that a wireless terminal might have addressed, e.g., international, domestic, local, previously-called numbers, never-before-called numbers, previously-emailed destinations, etc.;
a mix of destinations, e.g., international and local never-before-called numbers, etc.;
a statistical measure of the duration of calls made and/or received by a wireless terminal;
a statistical measure of the length of text messages sent and/or received by a wireless terminal;
keywords that were used in sent and/or received text messages;
call characteristics, e.g., duration, number of handovers, etc.;
a telecommunications (i.e., calling, texting, email, instant messaging, etc.) relationship between two terminals, for example, terminal T₁ has previously called terminal T₂, terminal T₁ has previously received text messages from terminal T₂, terminals T₁ and T₂ have previously participated in a conference call; etc.;
an indirect telecommunications relationship, e.g., terminal T₁ has a telecommunications relationship with terminal T₂, which has a telecommunications relationship with T₃, and therefore an indirect telecommunications relationship is inferred as between T₁ and T₃;
etc.

Recapping the example in the Summary of the Invention section in reference to locations A and B, an example of an investigation-specific rule is the location designated as A. Another exemplary investigation-specific rule is the location designated as B. Yet another exemplary investigation-specific rule is the timeframe surrounding the bomb blast, defined as the time period beginning one hour before the bomb blast and ending one hour after the bomb blast on the day of the bomb blast. Another exemplary investigation-specific rule identifies those wireless terminals that were activated for the first time within a short time (e.g., 48 hours) of the time of the bomb blast.

At operation 405, behavior analysis system 213 executes a filtering operation based on the one or more rules received in the preceding operation(s), thereby resulting in a corresponding set of candidate wireless terminals. According to the illustrative embodiment, the set of candidate wireless terminals corresponds only to the records that satisfy one or more of the investigation-specific rules. It will be clear to those having ordinary skill in the art, after reading the present disclosure, how to make and use alternative embodiments wherein the resulting set of candidate wireless terminals corresponds to all received records, even those that satisfy no rules. More details regarding this operation are given below and in the accompanying figure.

At operation 407, for each candidate in the set of candidate wireless terminals, behavior analysis system 213 generates a pattern of behavior. The pattern of behavior is based on telecommunications-event records that are associated with the given candidate over a period of time. For example, according to the illustrative embodiment, telecommunications-event records that are associated with the given candidate include without limitation:
a record wherein the wireless terminal received a call at a first location L₁, i.e., is the called party,
a record wherein the wireless terminal originated a call at a second location L₂, i.e., is the calling party,
a record wherein the wireless terminal executed a call transfer at a third location L₃,
a record wherein the wireless terminal received a text message at a fourth location L₄, and
a record wherein the wireless terminal originated a text message at a fifth location L₅.
   As noted earlier, numerous other records are associated with the wireless terminal according to the behavior thereof, based on other telecommunications events as listed above, without limitation. A pattern of behavior is preferably based at least in part on location data in the records. However, patterns of behavior according to the illustrative embodiment need not have a location component.

Examples of patterns of behavior for a given wireless terminal include one or more of the following, without limitation:
The total number of originating calls and/or texts and/or emails per day,
The total number of terminating calls and/or texts and/or emails per day,
The location that is associated with time or time periods, e.g., L₁ between 10 am and 12 pm on weekdays, L₂ at 1 pm daily, etc.,
The latitude and/or longitude range per day,
The number of international calls per time period, e.g., per week,
The number of wireless network cells visited per day, and
A statistical measure of calls, texts, and/or emails per time period, e.g., the weekly maximum, etc.
   The variety, granularity, periodicity, combinations, and complexity of the patterns of behavior will vary based on the parameters surrounding the respective investigation.

According to the illustrative embodiment, the period of time that is chosen for the exemplary investigation of the bomb blast is the period starting one year before the date of the bomb blast and ending one month before the date of the bomb blast. It will be further clear to those having ordinary skill in the art, after reading the present disclosure, how to make and use alternative embodiments using a different period of time and different relevant telecommunications-event records to generate a pattern of behavior. For example, a shorter period of time might be chosen; or perhaps only text messaging records might be chosen; etc. According to the illustrative embodiment, machine learning techniques that are well known in the art are used in the present operation to generate a pattern of behavior for each of the candidate wireless terminals. It will be clear to those having ordinary skill in the art, after reading the present disclosure, how to make and use alternative embodiments wherein other techniques generate the pattern of behavior, or a combination of machine learning and other techniques.

At operation 409, behavior analysis system 213 generates a ranking of the set of candidate wireless terminals relative to each other, based on:
(i) how precisely each candidate satisfies one or more of the rules received in the preceding operation(s), and/or
(ii) an aberration, if any, in behavior of each candidate wireless terminal relative to the pattern of behavior for the given candidate.

According to the illustrative embodiment, the present operation results in a ranked list wherein the “top of the list” comprises those candidates (i.e., the higher ranked candidates) that more precisely satisfy the rules and that also have an aberration in behavior relative to their respective pattern of behavior. Thus, the illustrative embodiment ranks based on both the preciseness factor and the aberration factor. Because the ranking is based on the investigation-specific rules and further because the aberration pertains to some aspects of the investigation, e.g., the day of the bomb blast, the resulting ranking also is investigation-specific. More details about the present operation are described below and in the accompanying figures.

It will be clear to those having ordinary skill in the art, after reading the present disclosure, how to make and use alternative embodiments wherein the present operation is limited to ranking based solely on the preciseness factor. It will be further clear to those having ordinary skill in the art, after reading the present disclosure, how to make and use alternative embodiments wherein the present operation is limited to ranking based solely on the aberration factor. It will be clear to those having ordinary skill in the art, after reading the present disclosure, how to make and use alternative embodiments wherein the present operation is based on a different ranking scheme involving the preciseness and aberration factors above, while still remaining within the scope of the present invention.

At operation 411, behavior analysis system 213 transmits the ranking of the candidate wireless terminals to one or more of the following destinations without limitation: a display, another system, e.g., a surveillance system, a data store, e.g., an archive, and any combination thereof. For example, according to the illustrative embodiment, behavior analysis system 213 transmits a ranked list of candidate wireless terminal to another system that is external to wireless network 200, and which is operated by law enforcement authorities. Further according to the illustrative embodiment, the ranked list is also transmitted to data store 214 where it is properly archived for future retrieval and analysis.

It will be clear to those skilled in the art, after reading the present disclosure, how to make and use alternative embodiments of method 400 wherein the operations are differently sequenced, grouped, or sub-divided—all within the scope of the present invention. It will be further clear to those skilled in the art, after reading the present disclosure, how to make and use alternative embodiments of method 400 wherein some of the recited operations are omitted or are executed by other elements of wireless network 200 and/or by systems that are external to wireless network 200.

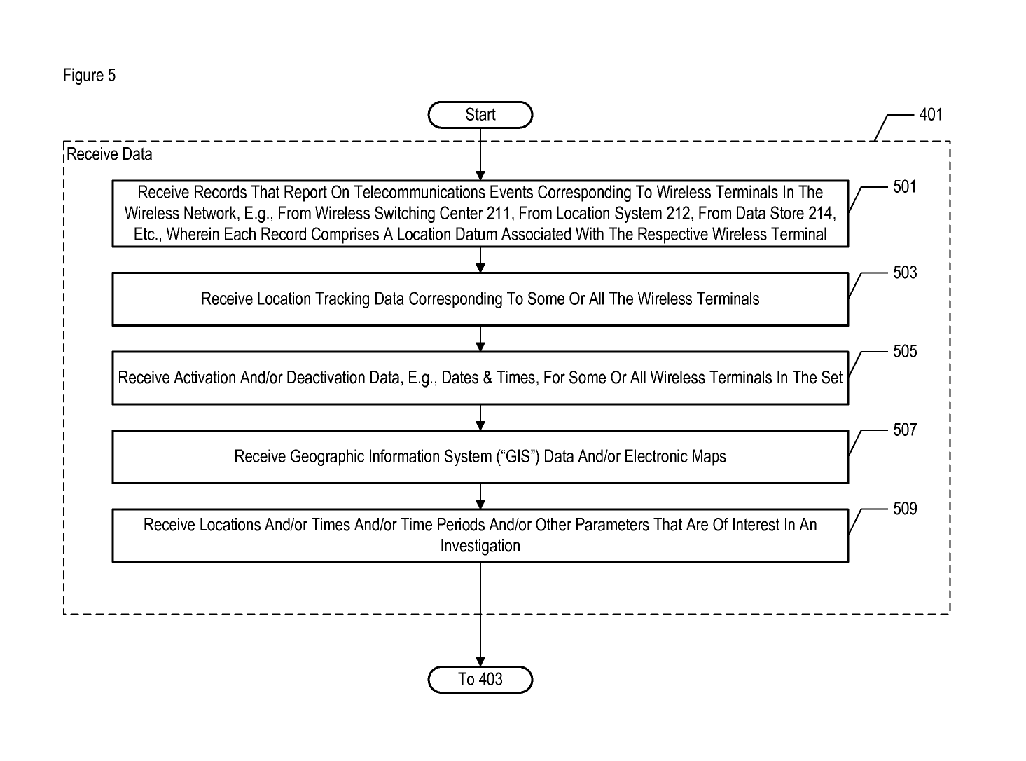

FIG. 5 depicts a flowchart of the salient sub-operations of operation 401 performed in accordance with the illustrative embodiment.

At operation 501, behavior analysis system 213 receives records that report on telecommunications events corresponding to wireless terminals in wireless network 200, wherein the records comprise location data that is associated with the respective wireless terminal. According to the illustrative embodiment, the records are received from wireless switching center 211. According to the illustrative embodiment, a record is received for every telecommunications event that is reported by wireless terminal 201 and also for every telecommunications event detected by any one of base stations 202 and 203. Each record comprises location information generated and provided by location system 212. As noted, depending on the capabilities of location system 212, the location information differs in resolution and granularity.

It will be clear to those having ordinary skill in the art, after reading the present disclosure, how to make and use alternative embodiments wherein the records are received from location system 212; or from data store 214; or wherein the records correspond to some but not all the telecommunications events reported by wireless terminal 201 and/or by any one of base stations 202 and 203. Although the illustrative embodiment continually receives records without limitation in time, it will be clear to those having ordinary skill in the art, after reading the present disclosure, how to make and use alternative embodiments in which the received records cover only certain periods of time. Although the illustrative embodiment continually receives records in respect to wireless network 200, it will be clear to those having ordinary skill in the art, after reading the present disclosure, how to make and use alternative embodiments in which records from another wireless network or networks are also received, such as from another wireless network that covers a similar geographic area as wireless network 200.

At operation 503, behavior analysis system 213 receives location tracking data that corresponds to some or all the wireless terminals in operation 501. Illustratively, the location tracking data is received from a surveillance system that is external to wireless network 200. The location tracking data provides location information that is additional to the records received from the elements of wireless network 200—information that could be useful in the subsequent analysis performed by behavior analysis system 213. It will be clear to those having ordinary skill in the art, after reading the present disclosure, how to make and use alternative embodiments that receive location tracking data from another source; or wherein behavior analysis system 213 distills, rather than receives, the location tracking data by analyzing existing telecommunications-events records, such as records from data store 214 or records 313.

At operation 505, behavior analysis system 213 receives activation and deactivation dates for some or all of the wireless terminals in operation 501. Illustratively, this data is received from wireless switching center 211, but it will be clear to those having ordinary skill in the art how to make and use an alternative embodiment wherein this data is received from another system within wireless network 200, such as a billing system; or from another system that is external to wireless network 200; or any combination of internal and external sources. Activation and deactivation data is used by the illustrative embodiment to flag activity around the time and/or location of interest, as potentially being out-of-the ordinary as compared to the vast majority of wireless terminals.

At operation 507, behavior analysis system 213 receives data from a Geographic Information System (“GIS”). GIS systems are well known in the art. It will be clear to those having ordinary skill in the art, after reading the present disclosure, how to make and use alternative embodiments that receive electronic map data other than a GIS; or any combination of GIS and non-GIS electronic mapping data and information.

At operation 509, behavior analysis system 213 receives data that is relevant to the present investigation, including without limitation: relevant locations, relevant times, relevant time periods, relevant behaviors, etc. Recapping the earlier bomb blast example, in the present operation, behavior analysis system 213 receives the location and time of the bomb blast, as well as additional relevant locations A and B.

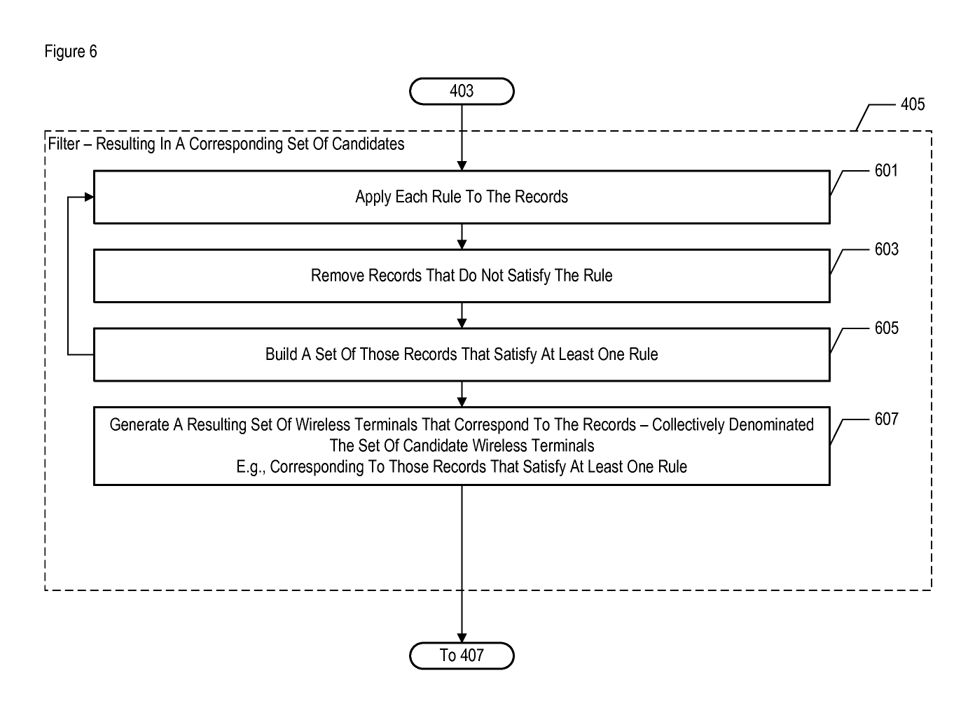

FIG. 6 depicts a flowchart of the salient sub-operations of operation 405 performed in accordance with the illustrative embodiment.

At operation 601, behavior analysis system 213 applies each of the previously-received rules to the previously-received records in a manner that is well known in the art.

At operation 603, behavior analysis system 213 sets aside or removes from further consideration those records that do not satisfy the applied rule. The records that satisfy the rule are retained for the next operation.

At operation 605, behavior analysis system 213 builds up a set of records wherein each record satisfies the rule. Control cycles back to operation 601 to consider and apply the next rule. After all rules have been applied, behavior analysis system 213 has built up a set of records that satisfy at least one of the investigation-specific rules.

At operation 607, behavior analysis system 213 generates a corresponding set of wireless terminals that correspond to the set of records—collectively denominated, for convenience, the set of candidate wireless terminals (candidates). Illustratively, the set of candidates corresponds to those records that satisfy one or more of the investigation-specific rules. Recapping the example above, the filtering according to the present operations results in a set of wireless terminals that satisfy one or more of the following rules:
Visited location A
Visited location B
Were active on a call during the defined timeframe of the bomb blast.

As noted earlier in regard to operation 405, an alternative embodiment of the present invention retains all telecommunications-event records by not executing operations 603 and 605. Consequently, at operation 607, the alternative embodiment generates a set of candidate wireless terminals that coincides with the set of all wireless terminals whose telecommunications-event records were received at operation 501. Thus, operation 405 filters the plurality of records, based on one or more rules, thereby resulting in a corresponding set of candidate wireless terminals. According to the alternative embodiment, any wireless terminal that is associated with a telecommunications-event record is a candidate whether its records satisfy any of the investigation-specific rule(s) or not.

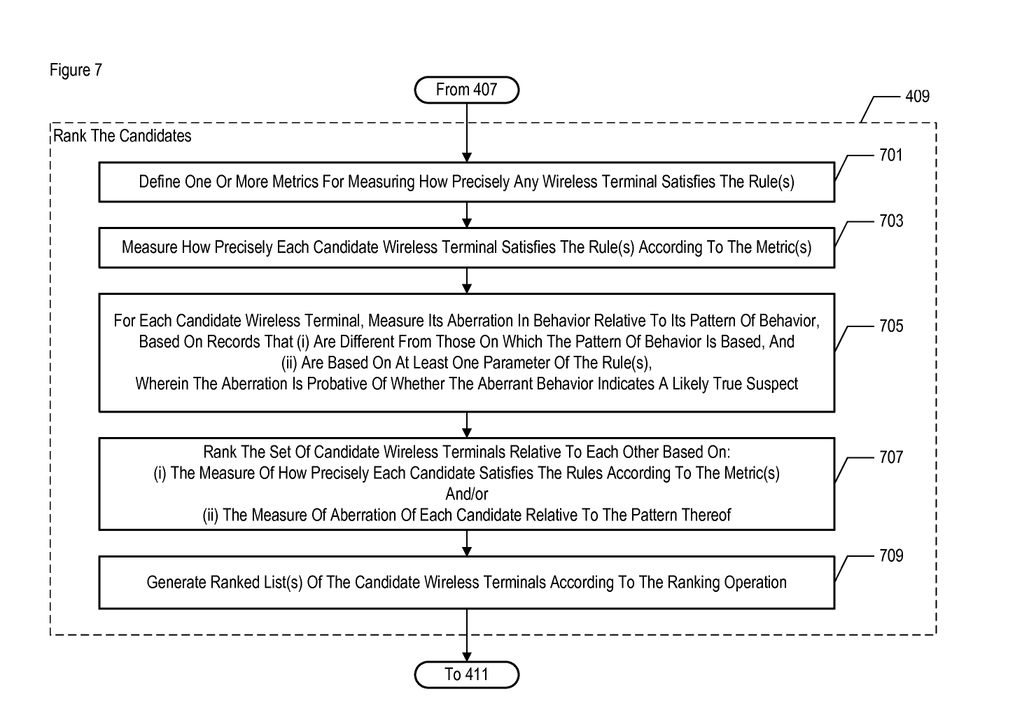

FIG. 7 depicts a flowchart of the salient sub-operations of operation 409 performed in accordance with the illustrative embodiment.

At operation 701, behavior analysis system 213 defines metrics for measuring how precisely (if at all) a wireless terminal satisfies the investigation-specific rules. Illustratively, a metric of how precisely a wireless terminal satisfies the rules is the number of rules that the wireless terminal satisfies according to the corresponding telecommunications-event records thereof. The number can range from none to all. It will be clear to those having ordinary skill in the art, after reading the present disclosure, how to define and use appropriate metrics that are useful and appropriate to an investigation.

At operation 703, behavior analysis system 213 measures how precisely each candidate wireless terminal satisfies the rules according to the above-defined metrics. Thus, according to the illustrative embodiment, a wireless terminal that satisfies two rules has a higher measure of preciseness than one that satisfies only one rule; the higher the number of satisfied rules, the higher the measure. Illustratively, a wireless terminal that visited both locations A and B has a higher measure of preciseness than one that visited only A or one that visited only B. As noted, the measure of preciseness is defined and chosen to be relevant to the investigation at hand.

At operation 705, behavior analysis system 213 further analyzes each candidate for aberrations in behavior, if any, in connection with the parameters of the investigation-specific rule(s) relative to the established pattern of behavior of the wireless terminal. An aberration is a departure from the normal or typical. An aberration in behavior of a wireless terminal is probative of whether a first behavior according to the aberration is more likely to be of interest in the investigation than a second behavior according to the pattern of behavior, i.e., whether a candidate that behaves according to the aberration is more likely to be a true suspect than one who conforms to the established pattern of behavior.

According to the illustrative embodiment, an aberration is identified when behavior analysis system 213 detects a departure from the pattern of behavior in at least one dimension or parameter. For example, a wireless terminal that never conducts multi-party calls according its pattern of behavior will be flagged with an aberration if records show that it conducted a multi-party call on the day of the bomb blast.

The aberration is analyzed relative to the respective pattern of behavior of the candidate. The aberration-related records are selected based on parameters of the investigation-specific rules. Typically, this means that that the aberration-related records are different from those on which the pattern of behavior is based. For example, the pattern of behavior is generated based on records dated January through April, but the aberration is measured based on other records that date to the month of May, which is the period of time in which the investigation is focused.

According to the illustrative embodiment, an aberration is measured according to how many parameters are breached as compared to the pattern of behavior. For example, a wireless terminal that, on the day of the bomb blast visits the same locations as usual at a different time than usual is assigned a measure of aberration. Another wireless terminal that fails to visit the usual locations altogether on the day of the bomb blast is assigned a higher measure of aberration, because it has breached more parameters (e.g., time of day breach and location breaches) as compared to its pattern of behavior. Another illustrative measure of aberration relates to multi-party calls, wherein a departure in the number and kind of multi-party calls conducted by a wireless terminal is defined as an aberration that is relevant to the investigation. Another illustrative measure of aberration relates to the number of never-before-called numbers, or never-before-received calls. It will be clear to those having ordinary skills in the art, after reading the present disclosure, how to devise alternative measures of aberration in behavior.

According to the illustrative embodiment, the measure of aberration in behavior of a candidate wireless terminal relative to the pattern of behavior thereof is based on at least one of, without limitation:
(i) a location parameter,
(ii) a time parameter,
(iii) a duration parameter,
(iv) a telephonic parameter,
(v) a data communication parameter.
   The measure of aberration is a collective representation of the degree of departure from the norm, and, as indicated above, can be based on more than one departure in more than one parameter, e.g., aberration in both location and time, movement rather than stationary behavior, indoor rather than outdoor behavior, using a never-before-used feature, receiving an email from a new sender, texting to a new destination, receiving a larger number of calls than the pattern, participating in conference calls never before conducted, etc. It will be clear to those having ordinary skill in the art, after reading the present disclosure, how to make and use an alternative embodiment that, when the aberration cannot be meaningfully quantified, uses a qualitative measure of the aberration, such as high, medium, and low; or uses a classification of the aberration that is based on the nature of the aberration, e.g., aberration or no-aberration. For example, an aberration in the time dimension may be considered less severe than an aberration in the location dimension; or an aberration in telephonic feature usage may be considered severe but an aberration in the time dimension might be disregarded as not a meaningful aberration. It will be clear to those having ordinary skills in the art, after reading the present disclosure, how to devise and measure aberration(s) such that they are relevant to the investigation at hand.

According to the illustrative embodiment, at least one record comprises a location datum that is associated with the reported-on telecommunications event, e.g., location L₁. The pattern of behavior is based at least in part on the location datum, e.g., the wireless terminal receives a call at location L₁ every day. Further according to the illustrative embodiment, the measure of aberration is based at least in part on the location datum in the record. According to the illustrative embodiment, the pattern of behavior is based at least in part on a first location parameter, e.g., the site of the bomb blast, and the measure of aberration is based at least in part on a second location parameter, e.g., a geofence comprising the site of the bomb blast.

In a more specific example according to the illustrative embodiment, the measure of aberration in behavior of a candidate wireless terminal is based on at least one of the following, without limitation:
(i) a location that is absent from the records on which the pattern of behavior is based,
(ii) a time that is absent from the records on which the pattern of behavior is based,
(iii) a duration that is absent from the records on which the pattern of behavior is based,
(iv) a telephonic parameter that is absent from the records on which the pattern of behavior is based,
(v) a data communication parameter that is absent from the records on which the pattern of behavior is based, and
(vi) a combination of any of (i) through (v), wherein the combination is absent from the records on which the pattern of behavior is based.

At operation 707, behavior analysis system 213 ranks the set of candidate wireless terminals based on:
(i) the measure of how precisely each candidate satisfies the applicable rules, and
(ii) the measure of aberration of each candidate wireless terminal relative to the pattern of behavior of the wireless terminal.

According to the illustrative embodiment, both factors contribute equally to the ranking, but it will be clear to those having ordinary skill in the art, after reading the present disclosure, how to make and use alternative embodiments wherein the ranking is based on only one of the above-listed factors; or wherein the factors receive unequal weights towards the collective rank. The measure of how precisely each candidate wireless terminal satisfies the rule is indicative of the likelihood that a given candidate is of higher interest relative to the other candidates. The measure of aberration is also indicative of the likelihood. As noted, the measure of aberration, as well its probative value as to the likelihood, are investigation-specific according to the circumstances of the investigation and the discretion of the investigators.

At operation 709, behavior analysis system 213 generates a ranked list of the candidate wireless terminals according to the preceding ranking operation. Those having the higher measure of preciseness coupled with the higher measure of aberration will rank higher, i.e., towards the “top” of the ranked list. According to the illustrative embodiment, individuals associated with such behaviors tend to be of higher interest in the investigation than other candidates and therefore will be higher ranked. Thus, in the bomb blast investigation example, a wireless terminal (and its user) that, on the day of the blast, visited both of the relevant sites A and B and also had unusual behavioral patterns relative to its established pattern of behavior is of more interest to the investigators and will therefore rank higher in the ranked list as compared to someone following their usual routine.

Thus, according to the illustrative embodiment, the rank of a candidate wireless terminal rises with an increase in the measure of aberration. Also, the rank of a candidate wireless terminal rises with an increase in the measure of how precisely the candidate satisfies the plurality of investigation-specific rule(s). Thus, the higher the measure of aberration, the higher the rank. Likewise, the higher the measure of preciseness, the higher the rank. It will be clear to those having ordinary skill in the art, after reading the present disclosure, how to devise alternative ranking criteria based on other measures or combinations of how precisely a wireless terminal satisfies the rules and how aberrant its behavior is relative to its established pattern of behavior.

An example of a ranked list appears in the table below:

TABLE 1

| | | Rule | Rule | | |
|---|---|---|---|---|---|
| | | #1: At | #2: AT | Precise- | |
| | International | Loca- | Loca- | ness In | Aber- |
| | Mobile | tion A | tion B | Satisfy- | ration |
| | Subscriber | During | During | ing | During |
| | Identity | Blast | Blast | The | Blast |
| Rank | (“IMSI”) | Time | Time | Rules | Time |
| 1 | sssssssssssssss | yes | yes | high | high |
| 2 | aaaaaaaaaaaaaaa | yes | yes | high | medium |
| 3 | mmmmmmmmmmmmmmm | no | no | low | high |
| 4 | uuuuuuuuuuuuuuu | no | yes | medium | medium |
| 5 | eeeeeeeeeeeeeee | yes | no | high | low |
| 6 | lllllllllllllll | yes | yes | medium | low |
| 7 | ppppppppppppppp | no | no | low | low |

Table 1 is merely illustrative of a ranked list of seven candidate wireless terminals that is generated by behavior analysis system 213 at operation 709 (notably, the IMSI is usually a number, but letters are used here for ease of readability). The relative weights assigned to the preciseness and aberration factors are such that a wireless terminal with low preciseness and high aberration measures (e.g., wireless terminal “aaaaaaaaaaaaaaa”) ranks higher at rank 3 relative to a wireless terminal that behaved with high preciseness to the rules and low aberration (e.g., wireless terminal “eeeeeeeeeeeeeee”), which ranks lower at rank 5. Illustratively, this is because aberrational behavior is more heavily weighed in this investigation than geo-temporal matching. As noted above, someone who routinely visits relevant locations A and B will rank lower than someone who did so aberrantly during the time frame of the bomb blast. Of course, in a different scenario according to another embodiment, visiting a particular series of locations as a pattern of behavior ranks higher than whether aberrant behavior was demonstrated in the time frame of the investigation. It will be clear to those having ordinary skill in the art, after reading the present disclosure, how to make and use alternative embodiments that measure, process, and weigh the preciseness and aberrance factors differently according to the discretion of the implementers, thereby resulting in a different ranking scheme than what Table 1 illustrates. It will be further clear to those having ordinary skill in the art, after reading the present disclosure, how to make and use alternative embodiments that generate a different body of information to accompany the ranked wireless terminals than what Table 1 illustrates—according to the discretion of the implementers.

It is to be understood that the disclosure teaches just some examples according to illustrative embodiments of the present invention and that many variations of the present invention can be devised by those skilled in the art after reading this disclosure. The scope of the present invention is to be determined by the following claims.

What is claimed is:

1. A method that is associated with a wireless network, the method comprising:
receiving, by a data-processing system, a plurality of records that report on telecommunications events associated with wireless terminals in the wireless network;
filtering the plurality of records, based on a rule, thereby resulting in a corresponding set of candidate wireless terminals, wherein the filtering is performed by the data-processing system;
for each candidate in the set, generating, by the data-processing system, a pattern of behavior that is based on records that are associated with the candidate;
ranking, by the data-processing system, the set of candidates relative to each other based on:
(a) a measure of aberration in behavior of each candidate wireless terminal relative to the respective pattern of behavior thereof; and
transmitting, by the data-processing system, the ranked set of candidate wireless terminals.

2. The method of claim 1 wherein the rule is one of a plurality of rules, and wherein the ranking is further based on:
(b) a measure of how precisely each candidate wireless terminal satisfies the plurality of rules.

3. The method of claim 1 wherein the aberration in behavior of each candidate wireless terminal is probative of whether the aberrant behavior indicates a likely true suspect.

4. The method of claim 1 wherein the measure of aberration is based on at least one parameter of the rule.

5. The method of claim 1 wherein the rank of a candidate rises, relative to other candidates, with an increase in at least one of:
(i) the measure of aberration in behavior of the candidate wireless terminal, and
(ii) a measure of how precisely the candidate wireless terminal satisfies the rule.

6. The method of claim 1 wherein at least one record comprises a location datum that is associated with the reported-on telecommunications event, and further wherein the pattern of behavior is based at least in part on the location datum.

7. The method of claim 1 wherein at least one record comprises a location datum that is associated with the reported-on telecommunications event, and further wherein the measure of aberration is based at least in part on the location datum.

8. The method of claim 1 wherein:
the pattern of behavior is based at least in part on a first location parameter, and
the measure of aberration is based at least in part on a second location parameter.

9. The method of claim 1 wherein the rule comprises at least one of:
(i) a location parameter,
(ii) a time parameter,
(iii) a duration parameter,
(iv) a telephonic parameter,
(v) a data communication parameter, and
(vi) a telecommunications relationship parameter.

10. The method of claim 1 wherein the resulting set of candidate wireless terminals corresponds only to those records that satisfy the rule.

11. The method of claim 1 further comprising:
measuring the aberration in behavior of each candidate wireless terminal based on records that (i) are different from the records on which the pattern of behavior is based, and (ii) are based on at least one parameter of the rule.

12. The method of claim 1 wherein the measure of aberration in behavior of a candidate wireless terminal is based on at least one of:
(i) a location that is absent from the records on which the pattern of behavior is based,
(ii) a time that is absent from the records on which the pattern of behavior is based,
(iii) a duration that is absent from the records on which the pattern of behavior is based,
(iv) a telephonic parameter that is absent from the records on which the pattern of behavior is based, and
(v) a data communication parameter that is absent from the records on which the pattern of behavior is based.

13. The method of claim 1 wherein the measure of aberration in behavior of a candidate wireless terminal is based on at least one of:
(i) a location parameter,
(ii) a time parameter,
(iii) a duration parameter,
(iv) a telephonic parameter,
(v) a data communication parameter, and
(vi) a telecommunications relationship parameter.

14. A method that is associated with a wireless network, the method comprising:
receiving, by a data-processing system, a plurality of records that report on telecommunications events associated with wireless terminals in the wireless network;
filtering the plurality of records, based on a plurality of rules, thereby resulting in a corresponding set of candidate wireless terminals, wherein the filtering is performed by the data-processing system;
for each candidate in the set, generating, by the data-processing system, a pattern of behavior that is based on records associated with the candidate;
ranking, by the data-processing system, the set of candidates relative to each other based on:
(a) a measure of how precisely each candidate wireless terminal satisfies the plurality of rules; and
transmitting, by the data-processing system, the ranked set of candidate wireless terminals.

15. The method of claim 14 wherein the ranking is further based on:
(b) a measure of aberration in behavior of each candidate wireless terminal relative to the respective pattern of behavior thereof;
wherein the measure of how precisely each candidate wireless terminal satisfies the rule is indicative of the likelihood that a given candidate is of higher interest relative to the other candidates; and
wherein the measure of aberration is also indicative of the likelihood.

16. The method of claim 14 wherein the measure of aberration in behavior of a candidate wireless terminal relative to the pattern of behavior thereof is based on at least one of:
(i) a location parameter,
(ii) a time parameter,
(iii) a duration parameter,
(iv) a telephonic parameter,
(v) a data communication parameter, and
(vi) a telecommunications relationship parameter.

17. A method that is associated with a wireless network, the method comprising:
receiving, by a data-processing system, a plurality of records that report on telecommunications events associated with wireless terminals in the wireless network;
filtering the plurality of records, based on a plurality of rules, thereby resulting in a set of candidate wireless terminals corresponding to those records that satisfy at least one rule in the plurality of rules, wherein the filtering is performed by the data-processing system;
for each candidate in the set, generating, by the data-processing system, a pattern of behavior that is based on records associated with the candidate over a period of time; ranking, by the data-processing system, the set of candidates relative to each other based on:
(a) a measure of aberration in behavior of each candidate wireless terminal relative to the respective pattern of behavior thereof, and
(b) a measure of how precisely each candidate wireless terminal satisfies the plurality of rules; and
transmitting, by the data-processing system, the ranked set of candidate wireless terminals.

18. The method of claim 17 wherein the rank of a candidate wireless terminal rises with an increase in the measure of aberration in behavior thereof.

19. The method of claim 17 wherein the rank of a candidate wireless terminal rises with an increase in the measure of how precisely the candidate wireless terminal satisfies the plurality of rules.

20. The method of claim 17 wherein the measure of aberration in behavior of a candidate wireless terminal relative to the pattern of behavior thereof is based on:
(A) a location parameter and
(B) at least one of:
(i) a time parameter,
(ii) a duration parameter,
(iii) a telephonic parameter,
(iv) a data communication parameter, and
(v) a telecommunications relationship parameter.
